(19) United States
(12) Patent Application Publication
(10) Pub. No.: US 2018/0048001 A1
(43) Pub. Date: Feb. 15, 2018

(54) HYDROGEN STORAGE CONTAINER

(71) Applicant: HONDA MOTOR CO., LTD., Tokyo (JP)

(72) Inventors: Yuka YANAGISAWA, Wako-shi, Saitama-ken (JP); Toshihiko KANEZAKI, Wako-shi, Saitama-ken (JP); Kotaro TANAKA, Wako-shi, Saitama-ken (JP); Tadahisa NAKAMURA, Wako-shi, Saitama-ken (JP)

(21) Appl. No.: 15/560,591

(22) PCT Filed: Mar. 23, 2016
(86) PCT No.: PCT/JP2016/059276

§ 371 Date: Sep. 22, 2017

(30) Foreign Application Priority Data
Mar. 26, 2015 (JP) 2015-063627

(51) Int. Cl. H01M 8/04; B32B 27/08; F17C 1/16; B32B 27/32; B32B 27/30; B32B 1/02; B32B 7/12

(52) U.S. Cl. CPC H01M 8/04; B32B 1/02; B32B 27/08; B32B 7/12; B32B 27/32; B32B 27/306; F17C 1/16; B32B 2307/7242; B32B 2439/00; H01M 2250/20; F17C 2203/0624; F17C 2203/066; F17C 2221/012

(57) ABSTRACT

A hydrogen storage container has an inner side resin layer that comes into contact with hydrogen gas that is introduced into the container, a barrier layer which is disposed on the outside of the inner side resin layer and which prevents permeation of hydrogen gas, and an outer side resin layer comprising a resin. Among these layers, the inner side resin layer comprises a polyethylene-based resin, and if the thickness of the barrier layer is denoted by Y and the thickness of the inner side resin layer is denoted by X, the thickness X satisfies formula (1). Moreover, D in formula (1) is the diffusion coefficient of the polyethylene-based resin, as determined by means of a differential pressure method at 50° C.

### TECHNICAL FIELD

The present invention relates to a hydrogen storage container having an inside resin layer, a barrier layer, and an outside resin layer arranged in this order from the inside.

### BACKGROUND ART

As is well known, in electric power generation in a fuel cell, it is necessary to supply a fuel gas such as a hydrogen gas to an anode. Therefore, for example, a fuel-cell vehicle having the fuel cell is equipped with a hydrogen storage container filled with the hydrogen gas. The fuel-cell vehicle is driven by supplying oxygen in the atmosphere as an oxygen-containing gas to a cathode of the fuel cell, supplying the hydrogen gas from the hydrogen storage container, reacting the hydrogen gas with the oxygen to generate electricity, and using the electricity to actuate a driving source.

In general, the hydrogen storage container is made up of a main body of a liner and a shell enclosing the liner. The liner is composed of a resin material such as a polyethylene naphthalate or a high-density polyethylene (HDPE), and the shell is composed of a fiber-reinforced material such as an FRP. Thus, the hydrogen storage container can be formed by covering a resin liner with a carbon fiber such as FRP or the like.

For example, Japanese Laid-Open Patent Publication No. 2000-220794 proposes a high-pressure container for hydrogen storage, which has inside and outside resin layers composed of the polyethylene naphthalate, and further has an intermediate layer interposed between the resin layers. Thus, when the high-pressure container is filled with a high-pressure hydrogen gas, the inside resin layer comes into contact with the hydrogen gas.

The intermediate layer acts as a barrier layer for blocking permeation of the hydrogen gas, and is made from a material such as an ethylene-vinyl alcohol copolymer (EVOH), as disclosed in the publication. Adhesive resin layers may be formed between the inside resin layer and the intermediate layer and between the intermediate layer and the outside resin layer if necessary.

### SUMMARY OF INVENTION

In the technology described in Japanese Laid-Open Patent Publication No. 2000-220794, the inside resin layer is arranged inside the intermediate layer (the barrier layer) for the purpose of achieving a sufficient pressure resistance in the hydrogen storage container. The polyethylene naphthalate in the inside resin layer is inferior in hydrogen barrier ability to metal materials. Therefore, by forming the intermediate layer as the barrier layer, the hydrogen gas is prevented from permeating through the container and being diffused into the atmosphere. In other words, lowering of the hydrogen gas pressure is prevented in the hydrogen storage container.

However, in this technology, the inside resin layer may be cracked and deteriorated at a relatively early stage in the use of the hydrogen storage container disadvantageously.

A principal object of the present invention is to provide a hydrogen storage container capable of preventing an inside resin layer from being cracked due to hydrogen molecules in a high-pressure hydrogen gas stored in the container.

According to an aspect of the present invention, there is provided a hydrogen storage container including:

an inside resin layer having at least an inner layer, which is brought into contact with a hydrogen gas when the hydrogen gas is introduced into the hydrogen storage container;

a barrier layer configured to block permeation of the hydrogen gas, and arranged outside the inside resin layer; and

an outside resin layer containing a resin, and arranged outside the barrier layer,

wherein

the inside resin layer contains a polyethylene-based resin, and

the thickness X of the inside resin layer and the thickness Y of the barrier layer satisfy the following inequality (1):

$$( \frac{75}{Y} ) \times {10}^{- 4} < X ≦ 70 \sqrt{D} \qquad ( 1 )$$

wherein D stands for a diffusion coefficient of the polyethylene-based resin, measured at 50° C. by a differential-pressure method.

Since the polyethylene-based resin has a relatively lower hydrogen barrier ability as described above, hydrogen molecules can enter the polyethylene-based resin of the inside resin layer. As a result of research in view of this problem, the present inventors have found that the inside resin layer made from the polyethylene-based resin is deteriorated relatively readily for the following reason. That is, once the hydrogen molecules enter the inside resin layer, the inside resin layer maintains such an entering state even after the hydrogen gas is discharged from the container (i.e. the container is depressurized) to operate the fuel cell.

Furthermore, the inventors have found that the barrier layer can maintain a sufficient barrier ability when the thicknesses of the barrier layer and the inside resin layer satisfy a particular condition.

In the present invention, the thickness X of the inside resin layer is controlled within a range satisfying the above inequality (1) based on the above findings. The hydrogen molecules that have entered the inside resin layer having the controlled thickness can be diffused in the inside resin layer and removed from the inside resin layer when the container is depressurized. In other words, the hydrogen molecules that have entered the inside resin layer do not remain in the inside resin layer, and are removed from the inside resin layer and released to the internal space of the hydrogen storage container. Thus, the state in which the hydrogen molecules are introduced into the inside resin layer is eliminated. Consequently, the inside resin layer (for example, composed of the polyethylene-based resin) can be prevented from being deteriorated due to the hydrogen molecules.

In addition, a sufficient pressure resistance can be achieved by forming the inside and outside resin layers, and permeation of the hydrogen gas can be prevented by forming the barrier layer. In other words, lowering of the hydrogen gas pressure in the container can be prevented. It is to be understood that the hydrogen permeability of the barrier layer is lower than those of the inside and outside resin layers.

As described above, the hydrogen storage container having a good pressure resistance, a good hydrogen barrier ability, and an excellent durability can be obtained by using the above structure.

For example, the polyethylene-based resin of the inside resin layer is preferably a high-density polyethylene (HDPE). In the case of using the HDPE, the inside resin layer can be easily formed at low cost.

The HDPE has a diffusion coefficient D of 4.62×10⁻¹⁰ m/second, measured at 50° C. by the differential-pressure method. Based on this value and the inequality (1), the thickness of the inside resin layer is preferably controlled to be 1.5 mm or less. In most of conventional hydrogen storage containers, the inside resin layers have thicknesses of 3 mm or more. In the present invention, the thickness of the hydrogen storage container can be reduced, and accordingly the weight thereof can be reduced.

The polyethylene-based resin of the inside resin layer may be a low-density polyethylene (LDPE). The LDPE has a diffusion coefficient D of 4.45×10⁻¹⁰ m/second measured at 50° C. by the differential-pressure method. Therefore, in this case, based on this diffusion coefficient value and the inequality (1), the thickness of the inside resin layer is preferably controlled to be 1.47 mm or less.

The thickness of the inside resin layer may be 1.4 mm or less as long as the inequality (1) is satisfied. In this case, the thickness and weight of the hydrogen storage container can be further reduced.

The inside resin layer may have the inner layer and an adhesive layer. In this case, the inner layer is attached to the barrier layer with the adhesive layer interposed therebetween. Therefore, the inner layer and the barrier layer are firmly bonded with the adhesive layer, so that the hydrogen molecules or the hydrogen gas can be prevented from remaining between the inner layer and the barrier layer.

The material of the barrier layer is preferably a resin having a small hydrogen permeability coefficient. Specific examples of such resins include ethylene-vinyl alcohol copolymer resin.

An adhesive layer may be formed between the barrier layer and the outside resin layer to bond the barrier layer and the outside resin layer. In this case, the outside resin layer is attached to the barrier layer with the adhesive layer interposed therebetween. Thus, the barrier layer and the outside resin layer are firmly bonded via the adhesive layer. Therefore, even hypothetically assuming that the hydrogen gas permeates through the barrier layer, the hydrogen gas can be prevented from remaining between the barrier layer and the outside resin layer. Consequently, the outside resin layer can be prevented from being peeled off from the barrier layer.

In the present invention, a diffusion distance is calculated based on the diffusion coefficient of the polyethylene-based resin measured at 50° C. by the differential-pressure method, and the thickness of the inside resin layer of the polyethylene-based resin is controlled to be equal to or less than the diffusion distance. Therefore, when the hydrogen storage container is depressurized, the hydrogen molecules that have entered the inside resin layer can be diffused in the inside resin layer and released from the inside resin layer to the internal space of the container. Consequently, the state, in which the hydrogen molecules are introduced into the inside resin layer, is eliminated, so that the inside resin layer can be prevented from being cracked (i.e. deteriorated) due to the hydrogen molecules. Thus, the hydrogen storage container can have an improved durability.

### BRIEF DESCRIPTION OF DRAWINGS

FIG. 1 is an overall, schematic, longitudinal sectional view of a hydrogen storage container according to an embodiment of the present invention;

FIG. 2 is an enlarged sectional view in the thickness direction, of main parts of the hydrogen storage container of FIG. 1;

FIG. 3 is an enlarged sectional view of main parts of an inner layer in the hydrogen storage container of FIG. 1, from which hydrogen molecules are removed; and

FIG. 4 is a schematic sectional view in the thickness direction, of a test specimen composed of an HDPE, observed after the test specimen is exposed to a pressurized hydrogen atmosphere.

### DESCRIPTION OF EMBODIMENTS

Several preferred embodiments of a hydrogen storage container of the present invention will be described in detail below with reference to the accompanying drawings.

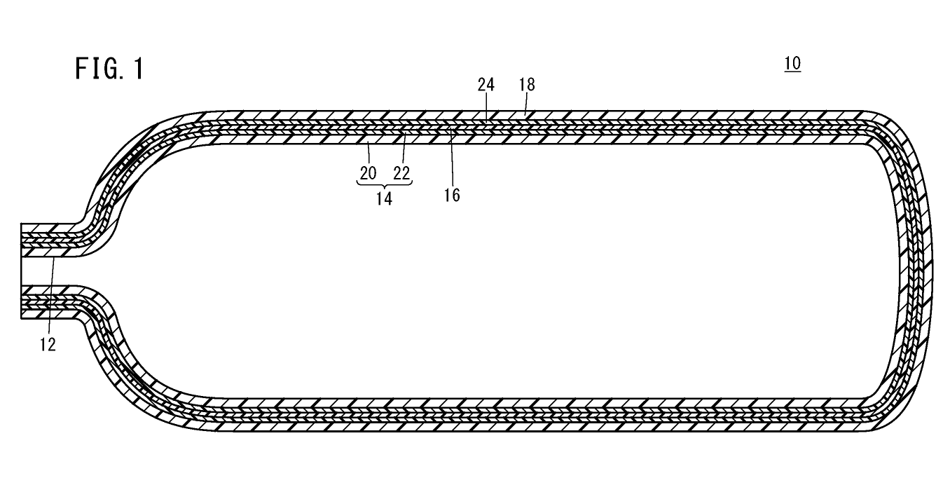

FIG. 1 is an overall, schematic, longitudinal sectional view of a hydrogen storage container 10 according to an embodiment. The hydrogen storage container 10 is a high-pressure container to be filled with a high-pressure hydrogen gas. For example, the hydrogen storage container is installed in a vehicle body to form a fuel-cell vehicle.

An opening 12 is formed at one end of the hydrogen storage container 10, a pipe joint is attached to the opening 12, and a pipe for supplying a hydrogen gas from the hydrogen storage container 10 to an anode of a fuel cell or a pipe for feeding a hydrogen gas from a hydrogen supply source into the hydrogen storage container is connected to the pipe joint. The fuel cell, the hydrogen supply source, the pipe, and the pipe joint are not shown in the drawing.

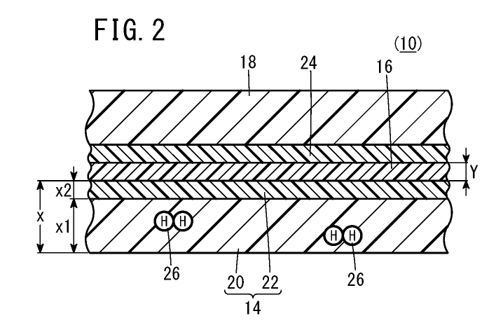

The hydrogen storage container 10 is made up of an inside resin layer 14, a barrier layer 16, and an outside resin layer 18 as main components. As shown in the enlarged view of FIG. 2, the inside resin layer 14 has two layers of an inner layer 20 and a first adhesive layer 22. A second adhesive layer 24 is interposed between the barrier layer 16 and the outside resin layer 18. In this embodiment, the inner layer 20 and the outside resin layer 18 comprises a high-density polyethylene (HDPE) resin, and the barrier layer 16 comprises an ethylene-vinyl alcohol copolymer (EVOH) resin. The first adhesive layer 22 and the second adhesive layer 24 preferably comprise a polyethylene-based resin, particularly preferably comprise a low-density polyethylene (LDPE) resin.

In this case, the inner layer 20 and the outside resin layer 18 can be easily prepared at low cost because the HDPE resin is inexpensive and easily workable. A sufficient pressure resistance can be achieved by forming the inner layer 20 and the outside resin layer 18.

The inner layer 20 and the barrier layer 16 can be bonded sufficiently firmly with the first adhesive layer 22, and the barrier layer 16 and the outside resin layer 18 can be bonded sufficiently firmly with the second adhesive layer 24. This is because the polyethylene-based resin in the first adhesive layer 22 and the second adhesive layer is a modified resin, which can adhere to both of the HDPE and EVOH resins. Therefore, a region between the inner layer 20 and the barrier layer 16 and a region between the barrier layer 16 and the outside resin layer 18 can be sufficiently sealed to prevent entry of hydrogen molecules 26 into the regions.

Furthermore, the barrier layer 16 acts to block permeation of the hydrogen gas. Thus, even hypothetically assuming that the hydrogen molecules 26 enter the inner layer 20 as shown in FIG. 2, further diffusion of the hydrogen molecules 26 is prevented by the barrier layer 16. Also the first adhesive layer 22 and the second adhesive layer 24, as well as the inside resin layer 14 and the outside resin layer 18, can act to block the permeation (diffusion) of the hydrogen gas. Therefore, diffusion of the hydrogen gas into the atmosphere is prevented.

In the above structure, the total of the thickness x1 of the inner layer 20 and the thickness x2 of the first adhesive layer 22, i.e. the thickness X of the inside resin layer 14 containing the inner layer 20 and the first adhesive layer 22, is more than 0 and equal to or less than a predetermined value. A method for obtaining the predetermined value will be described below.

In this method, in a case where the hydrogen storage container 10 is filled with the hydrogen gas and is then depressurized until a crack is generated in the inner layer 20, t_{c} represents a time from the depressurization start to the crack generation, and L_{c} represents a movement distance of the hydrogen molecule 26 in the inner layer 20 within the time t_{c}. L_{c} and t_{c} satisfy the following formula (2):

L_{c}=k\sqrt{Dt_{c}} (2)

In the formula (2), k is a proportionality constant, and D is a diffusion coefficient of the material measured at 50° C. by a differential-pressure method. The differential-pressure method is well known, and therefore detailed explanation thereof is omitted.

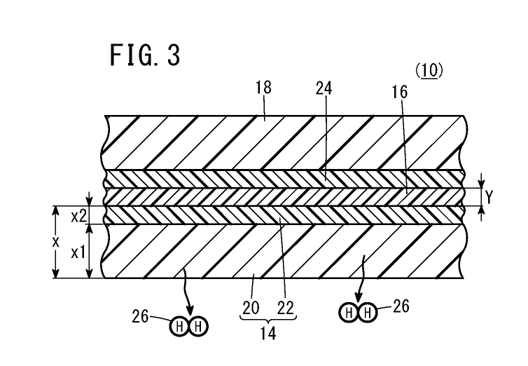

In a case where the thickness X is larger than the movement distance L_{c}, even after the hydrogen is supplied from the hydrogen storage container 10 to the anode in order to operate the fuel cell (even after the depressurization of the hydrogen storage container 10 is started), a state in which the hydrogen molecule 26 is introduced into the inner layer 20, is maintained. In contrast, in a case where the movement distance L_{c} is equal to or less than the thickness X, after the hydrogen storage container 10 is depressurized, the hydrogen molecule 26 can be removed from the inner layer 20 as shown in FIG. 3. The hydrogen molecule 26 can be moved by a distance equal to or larger than the thickness X in this case. Therefore, the thickness X is controlled to a value more than 0 and equal to or less than L_{c}. Thus, X and L_{c} satisfy the following inequality (3):

0<X≦L_{c} (3)

In the formula (2), the proportionality constant k is a constant value, and t_{c} is not changed or is changed only negligibly. Thus, both of k and t_{c} in the formula (2) can be considered as constant values. Then, a constant K is defined as a product of k and t_{c}^{1/2} as shown in the following formula (4):

K=k\sqrt{t_{c}} (4)

The following formula (5) is derived from the formulae (2) and (4):

L_{c}=K\sqrt{D} (5)

In the inside resin layer 14, the thickness x2 of the first adhesive layer 22 is negligibly smaller than the thickness x1 of the inner layer 20. Thus, x1 and x2 satisfy the condition of x1>>x2. Therefore, the thickness x1 of the inner layer 20 may be regarded as the thickness X of the inside resin layer 14 as described hereinafter.

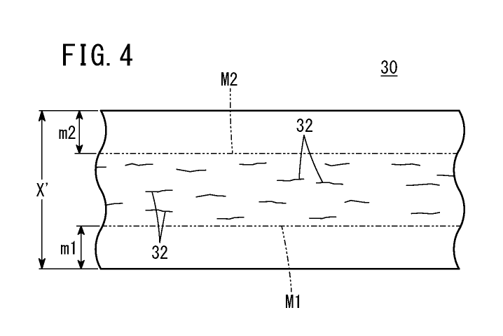

Next, for example, L_{c} is determined using a test specimen 30 shown in FIG. 4. The test specimen 30 is composed of the HDPE resin, and has a thickness X′ of 7 mm.

The test specimen 30 is left at 50° C. in a pressurized hydrogen atmosphere for a predetermined time. The exposed surfaces (end surfaces) of the test specimen 30 are pressed by the pressurized hydrogen gas. Then, the pressure of the atmosphere is reduced to a predetermined pressure. After this pressurized hydrogen treatment, the test specimen 30 is cut in the thickness direction. The cut surface is shown in FIG. 4.

In FIG. 4, cracks 32 are generated in a region enclosed by virtual lines M1 and M2. As shown in FIG. 4, the cracks 32 are generated in the internal region of the test specimen 30, and are not generated in the vicinity of the end surfaces. The distances m1 and m2 between the end surfaces and the virtual lines M1 and M2 are both 1.5 mm. Thus, each of the virtual lines M1 and M2 (the region with the cracks 32 generated) is separated a distance of 1.5 mm away from the end surface.

Consequently, the distance m1, m2 from the end surface to the virtual line M1, M2, i.e. the thickness of a region with no cracks 32 generated, corresponds to the movement distance L_{c} of the hydrogen molecule 26. Thus, the movement distance L_{c} is determined to be 1.5 mm.

The diffusion coefficient D of the HDPE, measured at 50° C. by the differential-pressure method, is 4.62×10⁻¹⁰ m/second. In this case, the constant K is calculated to be 70 by plugging in 4.62×10⁻¹⁰ m/second for D and 1.5 mm for L_{c} in the formula (5). The thickness X of the inside resin layer 14 is set to be equal to or less than L_{c} as described above, and thus may be 70×D^{1/2} or less. Therefore, based on the above (3) and (5), the thickness X and the diffusion coefficient D of the inside resin layer 14 satisfy the following inequality (6):

0<X≦70\sqrt{D} (6)

Next, the relation between the thickness X of the inside resin layer 14 and the thickness Y of the barrier layer 16 will be studied below. In this embodiment, the barrier layer 16 contains the EVOH as described above. In this case, when the barrier layer 16 has a water absorption of 2% by weight or more, it is difficult to ensure the barrier ability. The EVOH has a density of about 1.0 g/cm³. Therefore, when the barrier layer 16 with the thickness Y [mm] has a water absorption of 2% by weight, the water vapor permeation amount is 0.002Y [g/cm²].

In a test specimen that contains the inner layer and the first adhesive layer 22 and has the total thickness of 0.1 cm, a water vapor permeation rate was measured at 85°. The measured water vapor permeation rate was 1.5×10⁻⁵ [g/cm²·24 h]. Thus, when water vapor permeates through the inside resin layer 14 having the thickness of X mm in a 24-hour period, the water vapor permeation amount is 1.5×10⁻⁵/X [g/cm²].

In order to ensure the barrier ability of the barrier layer, the amount of the water vapor permeating through the inside resin layer 14 needs to be less than a water vapor permeation amount at which the water absorption of the barrier layer 16 is 2% by weight. Thus, it is necessary to satisfy the condition of the following inequality (7):

1.5×10⁻⁵/X<0.002Y (7)

This formula can be simplified in terms of X to obtain the following inequality (8):

X>(75/Y)×10⁻⁴ (8)

Based on the (6) and (8), the thickness X of the inside resin layer 14 is controlled in view of satisfying the following inequality (1):

$$( \frac{75}{Y} ) \times {10}^{- 4} < X ≦ 70 \sqrt{D} \qquad ( 1 )$$

In the case of controlling the thickness X of the inside resin layer 14 (the thickness x1 of the inner layer 20) within this range, when the hydrogen storage container is depressurized, the hydrogen molecules 26 that have entered the inner layer 20 can be diffused in the inner layer 20 and discharged to the internal space of the hydrogen storage container 10. Thus, the hydrogen molecules 26 can be returned into the internal space of the hydrogen storage container 10. Consequently, the state, in which the hydrogen molecules 26 are introduced into the inner layer 20, can be eliminated, whereby the inner layer can be prevented from being deteriorated due to the hydrogen molecules 26.

The inner layer 20 may contain an LDPE resin. The LDPE has a diffusion coefficient D of 4.45×10⁻¹⁰ m/second, measured at 50° C. by the differential-pressure method. In this case, the movement distance L_{c} of the hydrogen molecule 26 is calculated to be 1.47 mm by plugging in 4.45×10⁻¹⁰ m/second for D and the above obtained value 70 for K in the formula (5). Thus, in the case where the inner layer 20 contains the LDPE resin, the thickness X of the inside resin layer 14 (the thickness x1 of the inner layer 20) may be controlled to be 1.47 mm or less. Consequently, in the same manner as above, the state, in which the hydrogen molecules 26 are introduced into the inner layer 20, can be eliminated when the hydrogen storage container 10 is depressurized. Thus, also in this case, the inner layer 20 can be prevented from being deteriorated due to the hydrogen molecules 26.

The thickness X of the inside resin layer 14 can be controlled to 1.4 mm or less. In this case, the thickness of the hydrogen storage container 10 can be further reduced.

In any case, since the thicknesses X and Y are controlled to satisfy the condition of the inequality (1), the water vapor (moisture) can be prevented from permeating through the inner layer 20 and reaching the barrier layer 16. Therefore, lowering of the barrier ability of the barrier layer 16 is avoided, whereby leakage of the hydrogen gas from the hydrogen storage container 10 can be prevented.

The present invention is not particularly limited to the above-described embodiments, and various changes and modifications may be made therein without departing from the scope of the invention.

For example, the outside resin layer 18 may be covered with a carbon fiber or the like to form a shell structure.

One or both of the first adhesive layer 22 and the second adhesive layer 24 may be omitted. In the case of not using the first adhesive layer 22, the inner layer 20 may be used as the inside resin layer, and its thickness x1 may be controlled to a value of more than 0 and not more than 70×D^{1/2}.

### EXAMPLES

Multilayer test specimens were each produced by stacking a first layer of HDPE resin, a first adhesive layer of LDPE resin, a barrier layer of EVOH resin, a second adhesive layer of LDPE resin, and a second layer of HDPE resin in this order. The multilayer test specimens were different from each other in total thickness of the first layer and the first adhesive layer. The total thicknesses of the first layer and the first adhesive layer were set to be 0.3 mm, 1 mm, 3 mm, 4 mm, and 5 mm respectively.

Each of the multilayer test specimens was left in a pressurized hydrogen atmosphere at 50° C. for a predetermined time. In this treatment, the exposed surfaces of the first and second layers were pressed by the pressurized hydrogen gas. Then, the hydrogen gas pressure was reduced to a predetermined pressure, and each specimen was cut in the thickness direction.

Thus-obtained exposed cut surface of the first layer was evaluated with respect to whether a crack was generated or not. The results are shown in Table 1 in relation to the total thicknesses of the first layer and the first adhesive layer.

TABLE 1

| Total thickness of first layer and | |
|---|---|
| first adhesive layer [mm] | Crack |
| 0.3 | Not generated |
| 1 | Not generated |
| 3 | Generated |
| 4 | Generated |
| 5 | Generated |

As shown in Table 1, the crack was not generated when the total thickness of the first layer and the first adhesive layer was 1 mm or less, whereas the crack was generated when the total thickness was 3 mm or more. As is clear from the test results of the test specimens and a sample consisting of the HDPE resin, the cracking in the inside resin layer of the hydrogen storage container can be prevented by controlling the thickness X of the inside resin layer, which corresponds to the total thickness of the first layer and the first adhesive layer, to be 1.5 mm or less.

1. A hydrogen storage container comprising:
an inside resin layer having at least an inner layer, which is brought into contact with a hydrogen gas when the hydrogen gas is introduced into the hydrogen storage container;
a barrier layer configured to block permeation of the hydrogen gas, and arranged outside the inside resin layer; and
an outside resin layer containing a resin, and arranged outside the barrier layer,
wherein
the inside resin layer contains a polyethylene-based resin, and
thickness X of the inside resin layer and thickness Y of the barrier layer satisfy the following inequality:
$$( \frac{75}{Y} ) \times {10}^{- 4} < X ≦ 70 \sqrt{D} \qquad ( 1 )$$
wherein D stands for a diffusion coefficient of the polyethylene-based resin, measured at 50° C. by a differential-pressure method.

2. The hydrogen storage container according to claim 1, wherein the polyethylene-based resin of the inside resin layer is a high-density polyethylene.

3. The hydrogen storage container according to claim 2, wherein the inside resin layer has a thickness of 1.5 mm or less.

4. The hydrogen storage container according to claim 1, wherein the polyethylene-based resin of the inside resin layer is a low-density polyethylene.

5. The hydrogen storage container according to claim 4, wherein the inside resin layer has a thickness of 1.47 mm or less.

6. The hydrogen storage container according to claim 3, wherein the inside resin layer has a thickness of 1.4 mm or less.

7. The hydrogen storage container according to claim 1, wherein the inside resin layer has the inner layer and an adhesive layer, and the inner layer is attached to the barrier layer with the adhesive layer interposed therebetween.

8. The hydrogen storage container according to claim 1, wherein the barrier layer contains an ethylene-vinyl alcohol copolymer resin.

9. The hydrogen storage container according to claim 1, further comprising an adhesive layer arranged between the barrier layer and the outside resin layer to bond the barrier layer and the outside resin layer.
